(19) United States
(12) Patent Application Publication
(10) Pub. No.: US 2021/0119902 A1
(43) Pub. Date: Apr. 22, 2021

(54) MANAGEMENT DEVICE, INFORMATION PROCESSING SYSTEM, AND COMPUTER-READABLE RECORDING MEDIUM RECORDING MANAGEMENT PROGRAM

(71) Applicant: FUJITSU LIMITED, Kawasaki-shi (JP)

(72) Inventor: Naoki Iijima, Kawasaki (JP)

(73) Assignee: FUJITSU LIMITED, Kawasaki-shi (JP)

(21) Appl. No.: 17/031,976

(22) Filed: Sep. 25, 2020

(30) Foreign Application Priority Data
Oct. 18, 2019 (JP) 2019-191199

(51) Int. Cl. H04L 12/729; H04L 12/733; H04L 12/707; H04L 12/717; H04L 12/727; H04L 12/803; H04L 12/801

(52) U.S. Cl. CPC H04L 45/125; H04L 45/20; H04L 45/22; H04L 47/127; H04L 45/121; H04L 47/125; H04L 45/42

(57) ABSTRACT

A management device includes: a memory; and a processor coupled to the memory and configured to: acquire a transfer condition between a first processing device that backs up data related to a task, and each of a plurality of second processing devices that are candidates for a rearrangement destination of the task; and determine, as a processing device of the rearrangement destination, a processing device that satisfies a delay requirement related to delay time of processing in which the transfer condition is set for the task, among the plurality of second processing devices.

### CROSS-REFERENCE TO RELATED APPLICATION

This application is based upon and claims the benefit of priority of the prior Japanese Patent Application No. 2019-191199, filed on Oct. 18, 2019, the entire contents of which are incorporated herein by reference.

### FIELD

The embodiment discussed herein is related to a management device, an information processing system, and a management program.

### BACKGROUND

In recent years, since demand for high-speed processing for a large amount of data has increased, and problems such as network congestion and increase in a response delay occur in centralized processing in cloud, centralized processing is performed near a data generation source in some cases.

International Publication Pamphlet No. WO 2013/073020 and Japanese Laid-open Patent Publication No. 06-259478 are disclosed as related art.

### SUMMARY

According to an aspect of the embodiments, a management device includes: a memory; and a processor coupled to the memory and configured to: acquire a transfer condition between a first processing device that backs up data related to a task, and each of a plurality of second processing devices that are candidates for a rearrangement destination of the task; and determine, as a processing device of the rearrangement destination, a processing device that satisfies a delay requirement related to delay time of processing in which the transfer condition is set for the task, among the plurality of second processing devices.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining centralized processing and distributed processing of a large amount of data in a related example;

FIG. 2 is a block diagram illustrating an information processing system in a related example;

FIG. 3 is a diagram for explaining a failure recovery operation of stream data processing in the information processing system illustrated in FIG. 2;

FIG. 4 is a flowchart for explaining rearrangement processing in a management server illustrated in FIG. 2;

FIG. 5 is a block diagram for explaining the rearrangement processing in the management server illustrated in FIG. 2;

FIG. 6 is a diagram for explaining an outline of the rearrangement processing in an example of an embodiment;

FIG. 7 is a block diagram illustrating an information processing system in an example of an embodiment;

FIG. 8 is a block diagram schematically illustrating a hardware configuration example of a management server and a processing server illustrated in FIG. 7;

FIG. 9 is a block diagram schematically illustrating a functional configuration example of the management server and the processing server illustrated in FIG. 7;

FIG. 10 is a table exemplifying stream data information in the information processing system illustrated in FIG. 7;

FIG. 11 is a table exemplifying backup data information in the information processing system illustrated in FIG. 7;

FIG. 12 is a table exemplifying load information in the information processing system illustrated in FIG. 7;

FIG. 13 is a table exemplifying a task execution request in the information processing system illustrated in FIG. 7;

FIG. 14 is a table exemplifying data position management information in the information processing system illustrated in FIG. 7;

FIG. 15 is a table exemplifying execution task management information in the information processing system illustrated in FIG. 7;

FIG. 16 is a flowchart for explaining stream data collection processing in the processing server illustrated in FIG. 7;

FIG. 17 is a flowchart for explaining stream data processing in the processing server illustrated in FIG. 7;

FIG. 18 is a flowchart for explaining backup storage processing in the processing server illustrated in FIG. 7;

FIG. 19 is a flowchart for explaining load information collection processing in the processing server illustrated in FIG. 7;

FIG. 20 is a flowchart for explaining stream data interruption processing in the processing server illustrated in FIG. 7;

FIG. 21 is a flowchart for explaining stream data management processing in the management server illustrated in FIG. 7;

FIG. 22 is a flowchart for explaining details of allocation determination processing in step S62 of FIG. 21;

FIG. 23 is a flowchart for explaining details of the allocation determination processing in step S62 of FIG. 21;

FIG. 24 is a flowchart for explaining stream data position management processing in the management server illustrated in FIG. 7; and

FIG. 25 is a graph illustrating a relationship between the number of tasks and calculation time when obtaining a solution of a delay requirement in a related example and an example of the embodiment.

### DESCRIPTION OF EMBODIMENTS

For example, there is a system that collects video data from cameras distributedly installed over a wide area and performs stream data processing in a server in the vicinity. In such a system, in one server, processing of video data from multiple cameras is handled, and image recognition processing on each of detected objects is performed by detecting a motion (for example, a staggering action or an entering action) of a person or an object captured by the camera.

In order to perform such image recognition processing, many tasks are executed in the server. When a load on the server increases due to handling of many tasks, processing of the tasks is interrupted in some cases without being able to be ended within a specified time. Therefore, in order to allow a certain amount of a task processing delay and continue task processing, a user (in other words, for example, an operator) may set a delay requirement regarding an allowable delay time for every task.

However, due to an increase in the number of tasks to be processed and an increase in a load caused by a failure of a system such as a server, a delay requirement (in other words, for example, a delay request) set for every task may not be satisfied.

In one aspect, a processing device that satisfies a task delay requirement may be selected as a processing device of a task rearrangement destination.

Hereinafter, one embodiment will be described with reference to the drawings. However, the embodiment described below is merely an example, and there is no intention to exclude application of various modifications and techniques not explicitly illustrated in the embodiment. In other words, for example, the present embodiment may be variously modified and implemented without departing from the spirit thereof.

Furthermore, each figure is not intended to only include the constituent elements illustrated in the figure, and but includes other functions and the like.

Hereinafter, in the figures, each of the same reference numerals denotes the same part, and thus the description thereof will be omitted.

### [A] Related Example

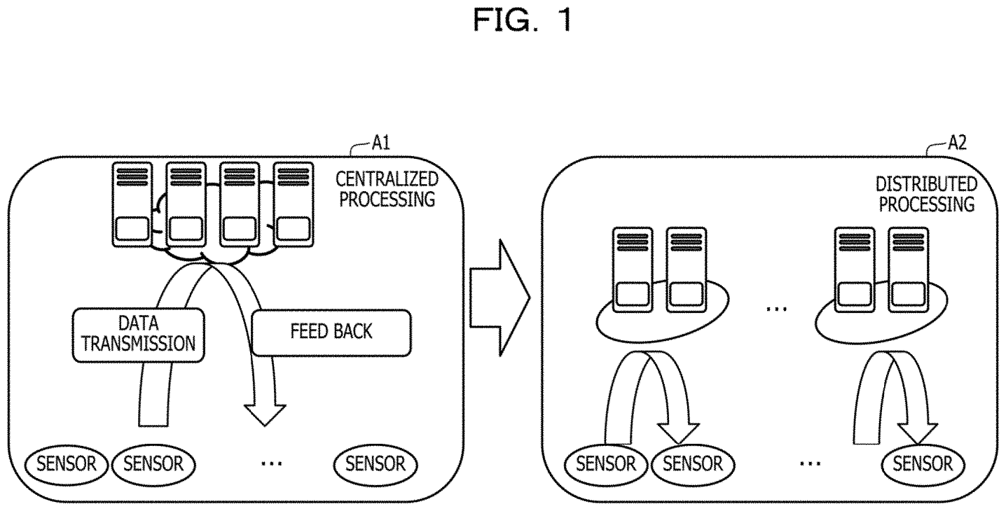

FIG. 1 is a diagram for explaining centralized processing and distributed processing of a large amount of data in a related example.

For example, in fields of safe driving support for vehicles and real-time monitoring and control of factories, high-speed processing of a large amount of data is performed.

In the centralized processing indicated by reference numeral A1 in FIG. 1, a large amount of data is all collected in cloud to be processed. However, due to a large amount of data transmission and feedback performed between a sensor and a data center, network congestion and an increased response delay may be a problem.

Therefore, in distributed processing indicated by reference numeral A2 in FIG. 1, by arranging a server near a sensor that is a data generation source to perform processing, a large amount of data may be processed at high speed.

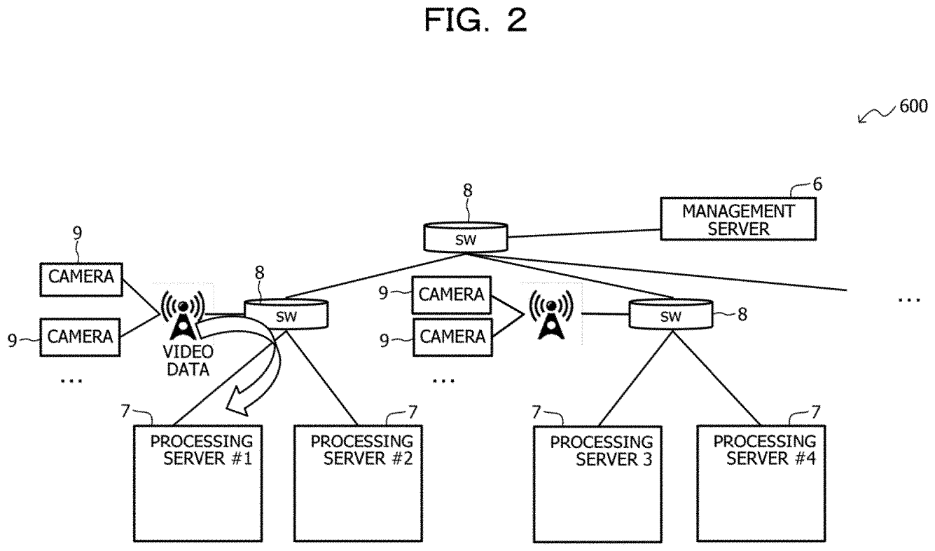

FIG. 2 is a block diagram illustrating an information processing system 600 in the related example.

The information processing system 600 includes a management server 6, a plurality of processing servers 7 (may be referred to as “processing servers #1 to #4”), a plurality of switches (SW) 8, and cameras 9. In the information processing system 600, video data is collected from the cameras 9 that are distributedly arranged over a wide area, and the processing server 7 in the vicinity performs stream data processing.

The management server 6 is connected to each processing server 7 via one or more SWs 8. Furthermore, each processing server 7 is connected to the camera 9 via one or more SWs 8.

Video data acquired from the plurality of cameras 9 is processed for each processing server 7. Each processing server 7 detects a person or an object captured by the camera 9, and performs pattern patch processing or the like on each detected object. For example, time-series data of a position of the captured person is processed, and a staggering action, an entering action into a restricted area, or the like is detected.

In such an information processing system 600, a monitoring requirement is set, and processing within a few seconds from capturing is desired. Furthermore, the management server 6 performs alive management of the processing server 7, load distributed processing of a process, and the like.

However, there is a possibility that a set delay requirement may not be satisfied due to an increase in a processing load caused by an occurrence of a failure in the processing server 7 or an increase in the number of objects captured by the camera 9.

Therefore, in order to satisfy the delay requirement, it is assumed that processing is rearranged among the individual processing servers 7.

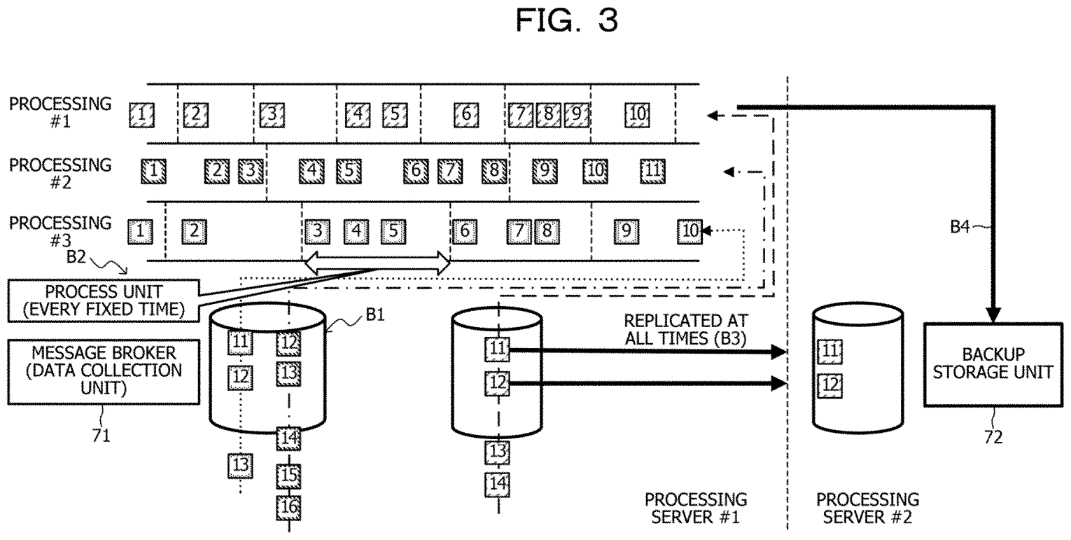

FIG. 3 is a diagram for explaining a failure recovery operation of stream data processing in the information processing system 600 illustrated in FIG. 2.

FIG. 3 illustrates an example in which a process being executed in one processing server 7 is restarted in another processing server 7, by replicating stream data and saving a processing state as a backup.

When the processing is restarted, the backup of the data is read, and data generated from the time when the backup is acquired to the present is reloaded to perform the processing.

In the illustrated example, a processing server #1 executes the stream data processing on data acquired from each camera 9 through processing #1 to #3, individually. Numbers surrounded by squares in individual processing represent time-series data.

As indicated by reference numeral B1, a message broker 71 (in other words, for example, a data collection unit) outputs data collected from the camera 9 and executes the stream data processing. As indicated by reference numeral B2, individual processing is divided into process units at every fixed time.

As indicated by reference numeral B3, the processing server #1 replicates the rearrangement target processing #1 to a processing server #2 at all times for backup.

Here, if a failure occurs in the processing server #1, as indicated by reference numeral B4, a backup storage unit 72 of the processing server #2 acquires, from the processing server #1, intermediate data in the middle of processing, information regarding up to which data has been read for the processing to be rearranged, and the like. Therefore, the processing server #2 may accept the rearrangement of the stream data processing from the processing server #1, to perform the failure recovery operation.

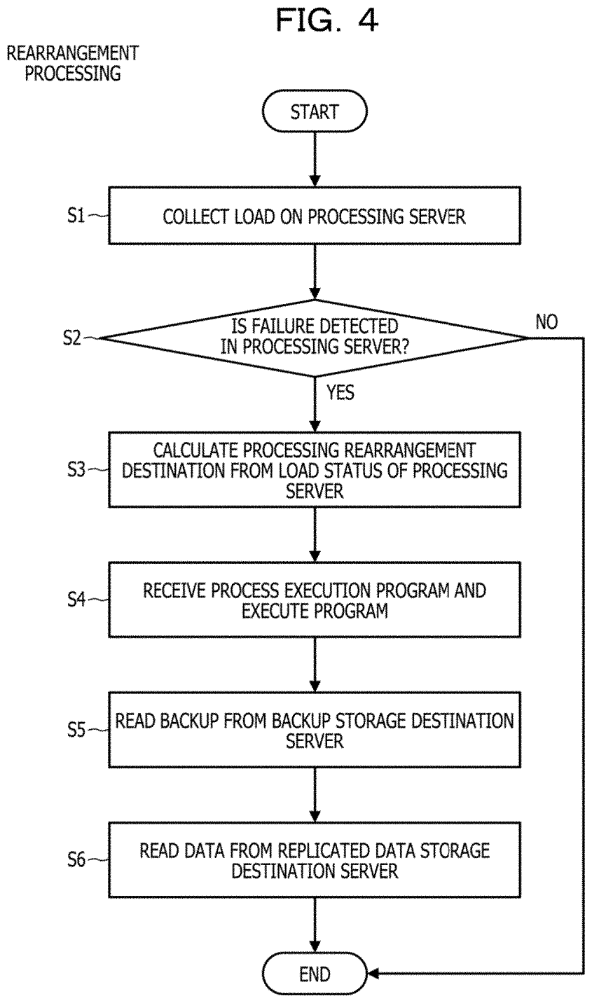

Rearrangement processing in the management server 6 illustrated in FIG. 2 will be described in accordance with a flowchart (steps S1 to S6) illustrated in FIG. 4.

The management server 6 collects a load on the processing server 7 (step S1).

The management server 6 determines whether a failure in the processing server 7 has been detected (step S2).

When no failure is detected (see a No route in step S2), the rearrangement processing ends.

Whereas, when a failure is detected (see a Yes route in step S2), the management server 6 calculates a processing rearrangement destination from a load status of the processing server 7 (step S3).

The processing server 7 of the rearrangement destination receives a process execution program from the processing server 7 of a rearrangement source and executes the program (step S4).

The processing server 7 of the rearrangement destination reads a backup from the processing server 7 of a backup storage destination (step S5).

The processing server 7 of the rearrangement destination reads data from the processing server 7 of a replicated data storage destination (step S6). Then, the rearrangement processing ends.

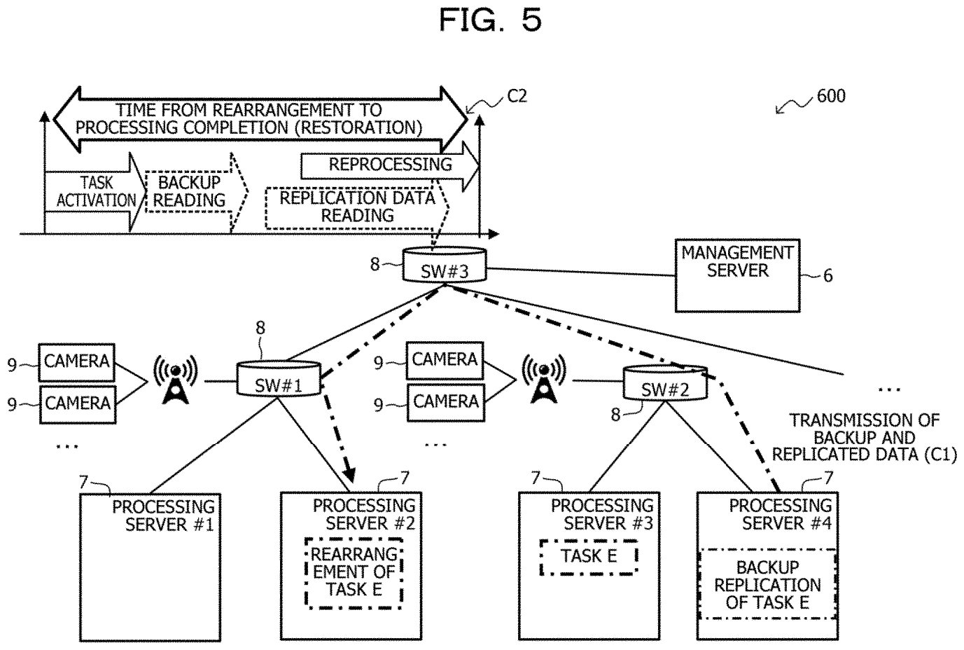

FIG. 5 is a block diagram for explaining the rearrangement processing in the management server 6 illustrated in FIG. 2.

In the example illustrated in FIG. 5, a task E is arranged in a processing server #3, and the backup replication of the task E in a processing server #4 is rearranged in the processing server #2 as a backup and replicated data, as indicated by reference numeral C1.

As indicated by reference numeral C2, time from rearrangement to completion (in other words, for example, restoration) of data stream processing is based on each time of task activation, backup reading, replication data reading, and reprocessing.

In the related example, a load on the processing server 7 is considered, but the delay requirement may not be satisfied since the task rearrangement destination is determined without consideration of a transfer delay caused by data transfer between the processing server 7 of a backup data replication storage destination and the processing server 7 of the rearrangement destination. In the example illustrated in FIG. 5, when a bandwidth between a SW #1 and the processing server #2 is narrow, the transfer delay caused by the data transfer may increase.

### [B] Example of Embodiment

### [B-1] System Configuration Example

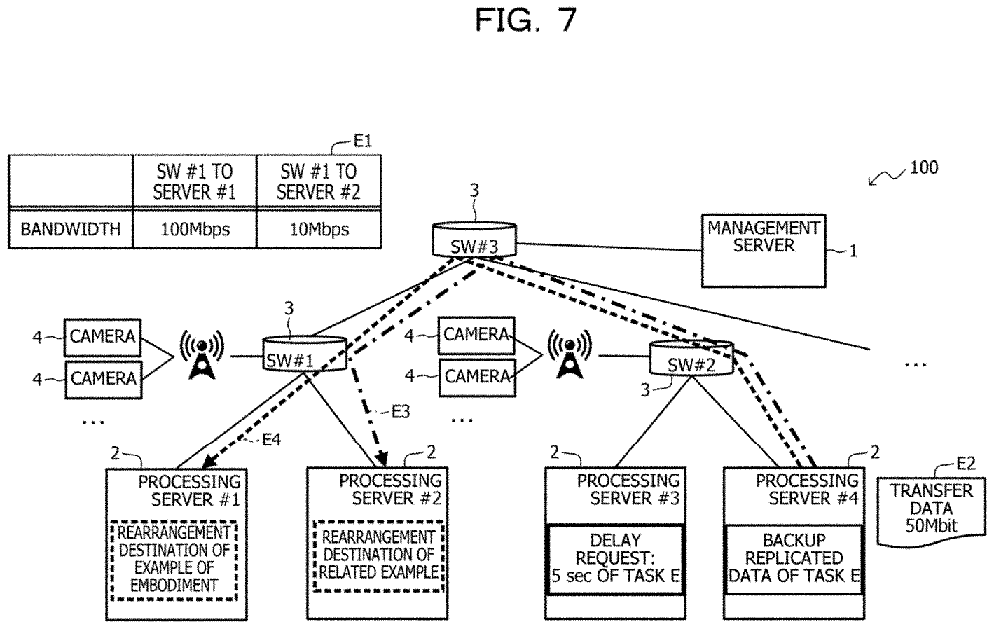

In an example of an embodiment, a processing server 2 of a replication storage destination of the backup data of each task or a task rearrangement destination is periodically determined, on the basis of a network status and a load status of the processing server 2 (described later with reference to FIG. 7, and the like).

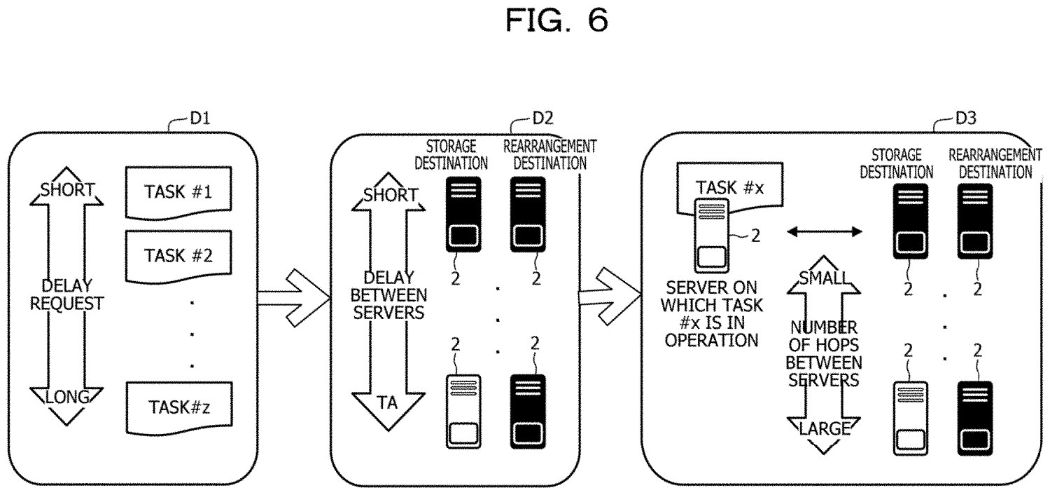

FIG. 6 is a diagram for explaining an outline of the rearrangement processing in an example of the embodiment.

In the rearrangement processing in the example of the embodiment, by performing multiple types of sorting for tasks and the processing servers 2, candidates for the processing server 2 of an optimal rearrangement destination are narrowed down, and high-speed calculation is possible even if the number of tasks and the number of servers increase.

As indicated by reference numeral D1, tasks are sorted in ascending order of allowable delay time in the delay requirement, and the rearrangement destination is determined sequentially from a task of the head.

As indicated by reference numeral D2, combinations of the processing servers 2 are sorted in ascending order of delay time related to a transfer delay (in other words, for example, a delay between servers) caused by data transfer between the processing server 2 of a backup replication storage destination and the processing server 2 of a task rearrangement destination. Therefore, the processing server 2 of the rearrangement destination is selected so that the delay requirement is satisfied as much as possible.

As indicated by reference numeral D3, tasks are selected in order of the sorting, and combinations of the processing servers 2 are sorted in ascending order of the number of hops from the processing server 2 on which the task is in operation to the processing server 2 of the backup replication storage destination. Therefore, the processing server 2 of the rearrangement destination is selected so that a path that consumes a bandwidth is as short as possible. This is repeatedly executed for the number of tasks.

In other words, for example, first, a plurality of tasks are sorted in ascending order of delay time.

Moreover, for each of the plurality of tasks, in order of the sorting, the processing server 2 of the rearrangement destination is determined in order of the processing server 2 having the smallest hop number. The number of hops is the number of SWs 3 (described later with reference to FIG. 7) installed between the processing server 2 of the backup source and the plurality of processing servers 2 of the rearrangement destination candidates of the task.

Next, in order of the sorting, for each of the plurality of tasks for which the processing server 2 of the rearrangement destination based on the number of hops has not been determined, processing devices of the rearrangement destination are determined in order of the processing server 2 having the largest network bandwidth. The network bandwidth is a bandwidth between the plurality of processing servers 2 of the rearrangement destination candidates and the SW 3 installed between the processing server 2 of the backup source and the plurality of processing servers 2 of the rearrangement destination candidates.

Note that the processing server 2 of the rearrangement destination may be determined based on the network bandwidth and then based on the number of hops.

FIG. 7 is a block diagram illustrating an information processing system 100 in an example of an embodiment.

The information processing system 100 includes a management server 1, a plurality of processing servers 2 (may be referred to as “processing servers #1 to #4”), a plurality of switches (SW) 3, and a plurality of cameras 4. In the information processing system 100, video data is collected from the cameras 4 that are distributedly arranged over a wide area, and the processing server 2 in the vicinity performs stream data processing.

The management server 1 is an example of a management device, and the processing server 2 is an example of a processing device. The management server 1 may be connected to each processing server 2 via one or more SWs 3. Furthermore, each processing server 2 may be connected to the camera 4 via one or more SWs 3.

Video data may be processed from the plurality of cameras 4 for each processing server 2. Each processing server 2 detects a person or an object captured by the camera 4, and performs pattern patch processing or the like on each detected object. For example, time-series data of a position of the captured person is processed, and a staggering action, an entering action into a restricted area, or the like is detected.

In the example illustrated in FIG. 7, as indicated by reference numeral E1, a bandwidth between a SW #1 and the processing server #1 is 100 Mbps, and a bandwidth between the SW #1 and the processing server #2 is 10 Mbps. Furthermore, as indicated by reference numeral E2, a size of transfer data regarding a task E is 50 Mbit.

As indicated by reference numeral E3, in the related example illustrated in FIG. 5 and the like, the task may be rearranged in the processing server #2 since a network bandwidth is not taken into consideration. If such rearrangement is performed, a transfer delay between the processing server #2 and the SW #1 is large, and thus the delay requirement may not be satisfied.

Whereas, in an example of the embodiment, the network bandwidth is considered. Therefore, as indicated by reference numeral E4, a task is allocated to the processing server #1 having a large network bandwidth with the SW #1, and the delay requirement may be satisfied.

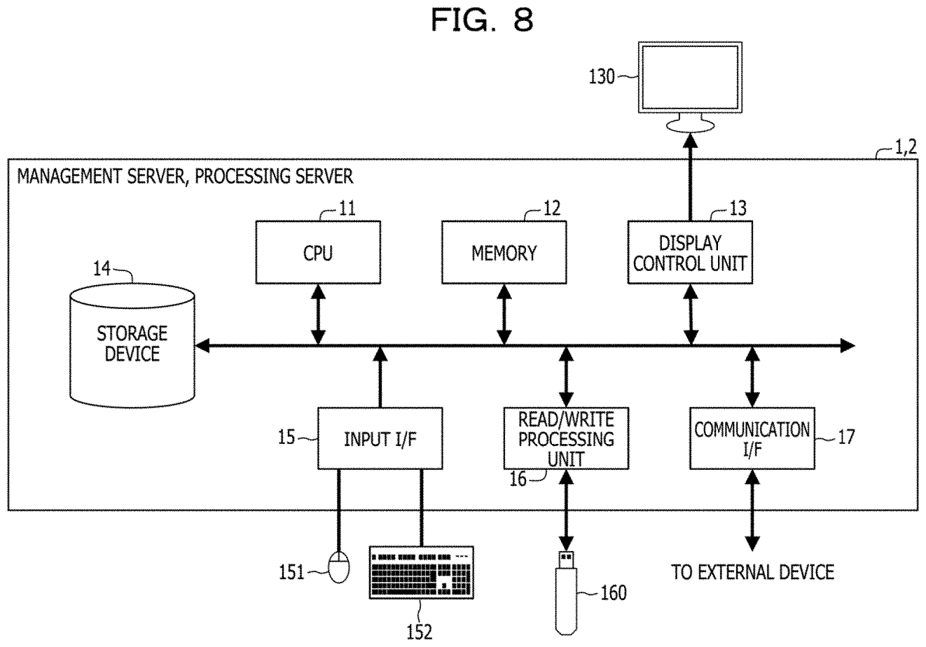

FIG. 8 is a block diagram schematically illustrating a hardware configuration example of the management server 1 and the processing server 2 illustrated in FIG. 7.

As illustrated in FIG. 8, the management server 1 and the processing server 2 include a CPU 11, a memory 12, a display control unit 13, a storage device 14, an input interface (I/F) 15, a read/write processing unit 16, and a communication I/F 17.

The memory 12 is an example of a storage unit, and is exemplarily a storage device including a read only memory (ROM) and a random access memory (RAM). In the ROM of the memory 12, a program such as a basic input/output system (BIOS) may be written. A software program of the memory 12 may be appropriately read and executed by the CPU 11. Furthermore, the RAM of the memory 12 may be used as a primary recording memory or a working memory.

The display control unit 13 is connected to a display device 130 and controls the display device 130. The display device 130 is a liquid crystal display, an organic light-emitting diode (OLED) display, a cathode ray tube (CRT), an electronic paper display, or the like, and displays various types of information for an operator or the like. The display device 130 may be combined with an input device, and may be, for example, a touch panel.

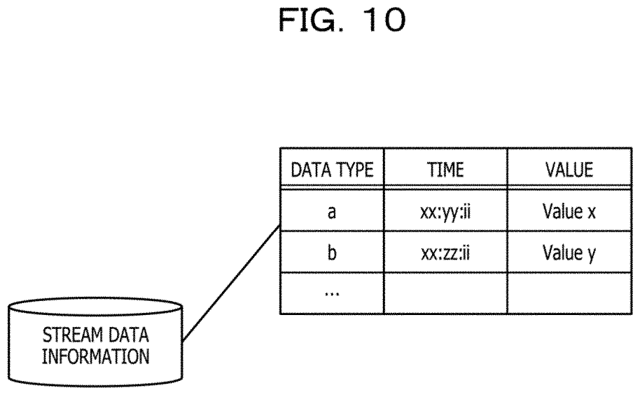

The storage device 14 is exemplarily a device that reads and writes data and stores the data. For example, a harddisk drive (HDD), a solid state drive (SSD), or a storage class memory (SCM) may be used. The storage device 14 may store stream data information, backup data information, load information, a task execution request, data position management information, and execution task management information, which will be individually described later with reference to FIGS. 10 to 15.

The input I/F 15 may be connected to an input device such as a mouse 151 and a keyboard 152, and control the input device such as the mouse 151 and the keyboard 152. The mouse 151 and the keyboard 152 are examples of an input device, and an operator performs various input operation via these input devices.

The read/write processing unit 16 is configured so that a recording medium 160 may be mounted. The read/write processing unit 16 is configured to be able to read information recorded in the recording medium 160 in a state where the recording medium 160 is mounted. In this example, the recording medium 160 has portability. For example, the recording medium 160 is a flexible disk, an optical disk, a magnetic disk, a magneto-optical disk, a semiconductor memory, or the like.

The communication I/F 17 is an interface that enables communication with an external device.

The CPU 11 is a processing device that performs various controls and calculations, and implements various functions by executing an operating system (OS) and programs stored in the memory 12.

The device for controlling an overall operation of the management server 1 and the processing server 2 is not limited to the CPU 11, and may be any one of an MPU, a DSP, an ASIC, a PLD, and an FPGA, for example. Furthermore, the device for controlling the overall operation of the management server 1 and the processing server 2 may be a combination of two or more of the CPU, the MPU, the DSP, the ASIC, the PLD, and the FPGA. Note that the MPU is an abbreviation for micro processing unit, the DSP is an abbreviation for digital signal processor, and the ASIC is an abbreviation for application specific integrated circuit. Furthermore, the PLD is an abbreviation for programmable logic device, and the FPGA is an abbreviation for fieldprogrammable gate array.

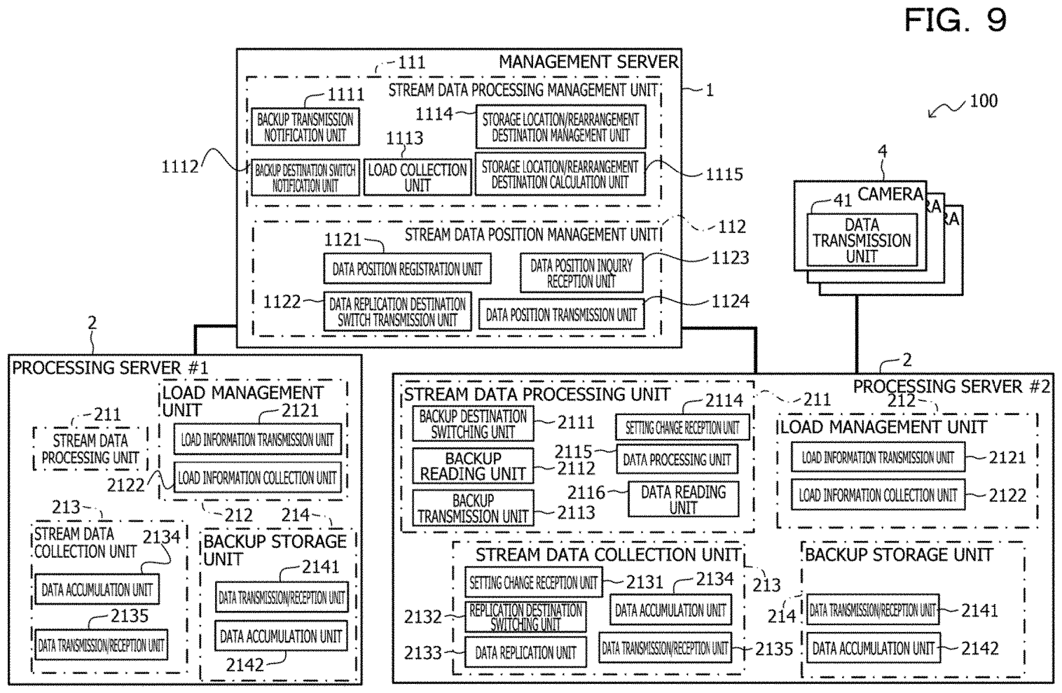

FIG. 9 is a block diagram schematically illustrating a functional configuration example of the management server 1 and the processing server 2 illustrated in FIG. 7.

As illustrated in FIG. 9, the CPU 11 of the management server 1 functions as a stream data processing management unit 111 and a stream data position management unit 112 by executing a program (in other words, for example, a management program).

The stream data processing management unit 111 functions as a backup transmission notification unit 1111, a backup destination switch notification unit 1112, a load collection unit 1113, a storage location/rearrangement destination management unit 1114, and a storage location/rearrangement destination calculation unit 1115.

The backup transmission notification unit 1111 transmits a notification for creating a backup to the processing server 2.

The backup destination switch notification unit 1112 transmits a notification for changing a backup destination to the processing server 2.

The load collection unit 1113 collects a sewer load and a bandwidth load from each processing server 2 and network equipment such as the SW 3.

In other words, for example, the load collection unit 1113 is an example of an acquisition unit, and acquires a transfer condition between the first processing server 2 that backs up data related to the task and each of a plurality of second processing servers 2 that are candidates for the task rearrangement destination. Note that the transfer condition may be the number of hops according to the number of SWs 3 installed between the first processing server 2 and the plurality of second processing servers 2. Furthermore, the transfer condition may be a network bandwidth between the plurality of second processing servers 2 and the SW 3 installed between the first processing server 2 and the plurality of second processing servers 2.

The load collection unit 1113 may acquire loads on the plurality of second processing servers 2 in addition to the transfer condition.

The storage location/rearrangement destination management unit 1114 manages a combination of the processing server 2 that backs up processing and the processing server 2 to which processing is rearranged.

The storage location/rearrangement destination calculation unit 1115 calculates a combination of the processing server 2 that backs up processing and the processing server 2 to which processing is rearranged.

In other words, for example, the storage location/rearrangement destination calculation unit 1115 is an example of a determination unit, and determines, as the processing server 2 of the rearrangement destination, the processing server 2 whose transfer condition satisfies a delay requirement regarding the task, among the plurality of second processing servers 2.

The storage location/rearrangement destination calculation unit 1115 may preferentially determine, as the processing server 2 of the rearrangement destination, the processing server 2 having a low load among the plurality of second processing servers 2.

The stream data position management unit 112 functions as a data position registration unit 1121, a data replication destination switch transmission unit 1122, a data position inquiry reception unit 1123, and a data position transmission unit 1124.

The data position registration unit 121 registers which processing server 2 stores stream data.

The data replication destination switch transmission unit 1122 transmits a notification for changing a transmission destination of replicated data, to a stream data collection unit 213 described later of the processing server 2.

The data position inquiry reception unit 1123 receives an inquiry about a data position from the processing server 2.

The data position transmission unit 1124 transmits a data position (in other words, for example, which processing server 2 stores the data) to the processing server 2.

As illustrated in FIG. 9, the CPU 11 of the processing server 2 functions as a stream data processing unit 211, a load management unit 212, the stream data collection unit 213, and a backup storage unit 214 by executing a program.

The stream data processing unit 211 functions as a backup destination switching unit 2111, a backup reading unit 2112, a backup transmission unit 2113, a setting change reception unit 2114, a data processing unit 2115, and a data reading unit 2116.

Upon receiving a backup destination switch notification from the management server 1, the backup destination switching unit 2111 switches the processing server 2 of the backup destination.

The backup reading unit 2112 reads a backup from the backup storage unit 214 of the designated processing server 2.

The backup transmission unit 2113 creates a backup and transmits the backup to the processing server 2 of the backup storage destination.

The setting change reception unit 2114 receives a backup destination change notification from the management server 1.

The data processing unit 2115 processes data acquired from the camera 4 or another processing server 2.

The data reading unit 2116 reads desired data from the stream data collection unit 213.

The load management unit 212 functions as a load information transmission unit 2121 and a load information collection unit 2122.

The load information transmission unit 2121 transmits load information of its own processing server 2 to the management server 1.

The load information collection unit 2122 periodically collects load information of its own processing server 2.

The stream data collection unit 213 functions as a setting change reception unit 2131, a replication destination switching unit 2132, a data replication unit 2133, a data accumulation unit 2134, and a data transmission/reception unit 2135.

The setting change reception unit 2131 receives a change notification for a replicated data storage destination from the management server 1.

The replication destination switching unit 2132 changes the processing server 2 of a data replication destination in accordance with the change notification for the replicated data storage destination.

The data accumulation unit 2134 accumulates received stream data in a database.

The data transmission/reception unit 2135 receives stream data and transmits the data to the processing server 2 of the data replication destination. Furthermore, the data transmission/reception unit 2135 transmits corresponding data in response to a request from the stream data processing unit 211.

The backup storage unit 214 functions as a data transmission/reception unit 2141 and a data accumulation unit 2142.

The data transmission/reception unit 2141 receives a backup from another processing server 2. Furthermore, the data transmission/reception unit 2141 transmits a backup requested by another processing server 2.

The data accumulation unit 2142 accumulates the received backup in a database.

The camera 4 has a function as a data transmission unit 41.

The data transmission unit 41 transmits video data obtained by capturing to the stream data collection unit 213 of the processing server 2.

FIG. 10 is a table exemplifying stream data information in the information processing system 100 illustrated in FIG. 7.

The stream data information is managed by each processing server 2, and indicates stream data to be processed in its own processing server 2. The stream data information is associated with a data type, a time, and a value.

The data type has a different value for each camera 4 used for capturing. The time is a time at which the capturing of the stream data is started. The value indicates a content of the stream data.

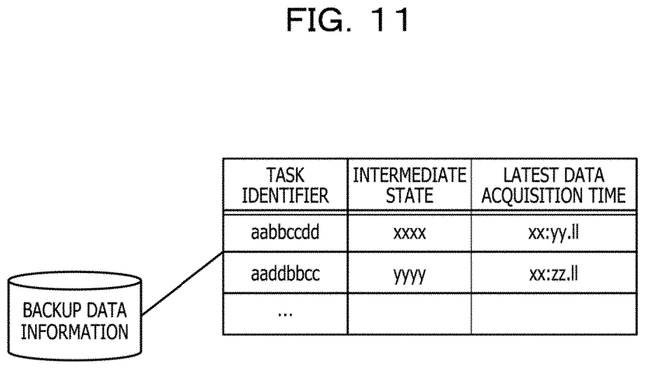

FIG. 11 is a table exemplifying backup data information in the information processing system 100 illustrated in FIG. 7.

The backup data information is information regarding backup data managed by each processing server 2 and stored in its own processing server 2. The backup data information is associated with a task identifier, an intermediate state, and a latest data acquisition time.

The task identifier is a value for identifying a task that has been backed up, The intermediate state is binary data indicating progress for calculation of backup data. The latest data acquisition time indicates the latest time when the backup data has been acquired.

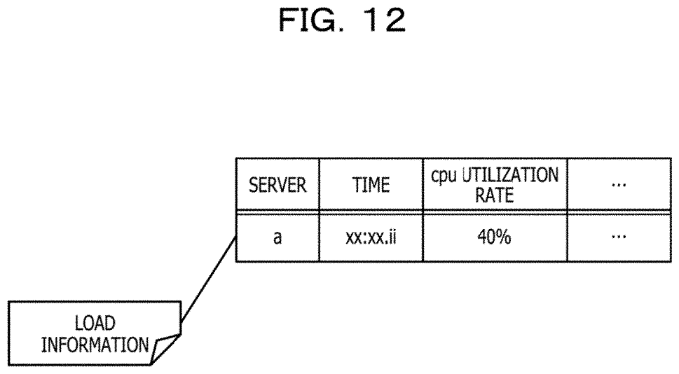

FIG. 12 is a table exemplifying load information in the information processing system 100 illustrated in FIG. 7.

The load information is information indicating a load occurring in each processing server 2. The load information is associated with, for example, a server, a time, and a cpu utilization rate.

The server indicates the processing server 2 from which the load information has been acquired. The time indicates a time at which the load information has been acquired. The cpu utilization rate indicates a utilization rate of the CPU 11 in the processing server 2.

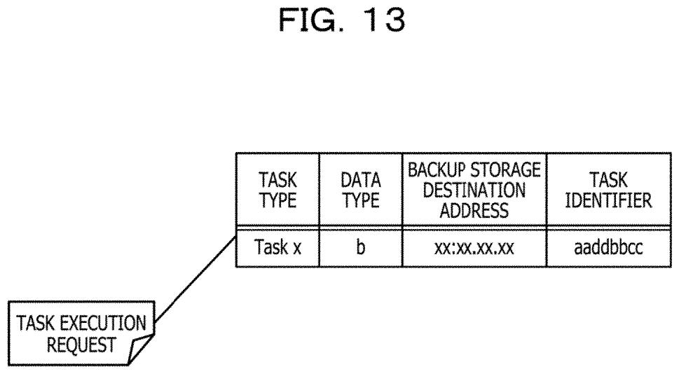

FIG. 13 is a table exemplifying a task execution request in the information processing system 100 illustrated in FIG. 7.

The task execution request indicates a content of task execution requested to the processing server 2. The task execution request is associated with a task type, a data type, a backup storage destination address, and a task identifier.

The task type is a value for identifying a task related to the task execution request. The data type has a different value for each camera 4 used for capturing. The backup storage destination address indicates an address of the processing server 2 of a storage destination of backup data corresponding to the task. The task identifier is a value for identifying the task that has been backed up. Note that, when there is no backup data corresponding to the task, values of the backup storage destination address and the task identifier are to be empty.

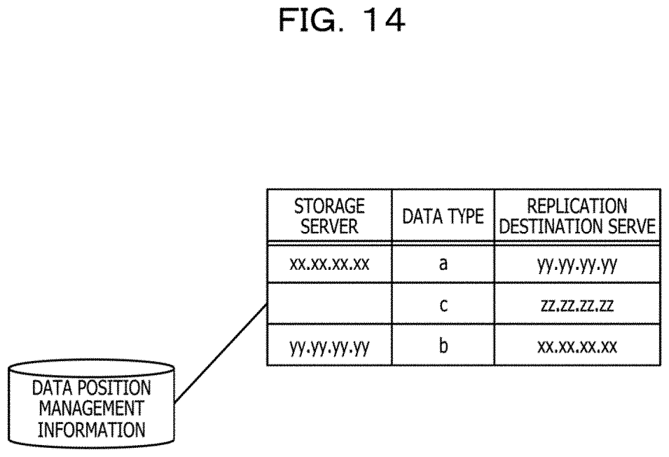

FIG. 14 is a table exemplifying data position management information in the information processing system 100 illustrated in FIG. 7.

The data position management information is associated with a storage server, a data type, and a replication destination server.

The storage server is an address of the processing server 2 that stores original stream data. The data type has a different value for each camera 4 used for capturing. The replication destination server is an address of the processing server 2 that stores the replicated stream data.

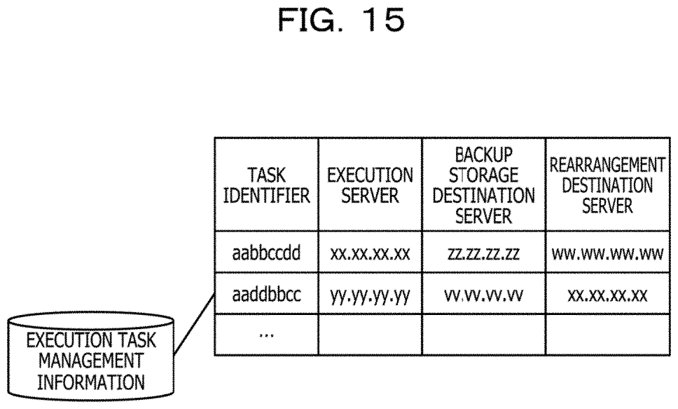

FIG. 15 is a table exemplifying execution task management information in the information processing system 100 illustrated in FIG. 7.

The execution task management information is associated with a task identifier, an execution server, a backup storage destination server, and a rearrangement destination server.

The task identifier is a value for identifying a task that has been backed up. The execution server is an address of the processing server 2 that executes the task. The backup storage destination server is an address of the processing server 2 that stores a backup of the task. The rearrangement destination server is an address of the processing server 2 of a task rearrangement destination.

### [B-2] Operation Example

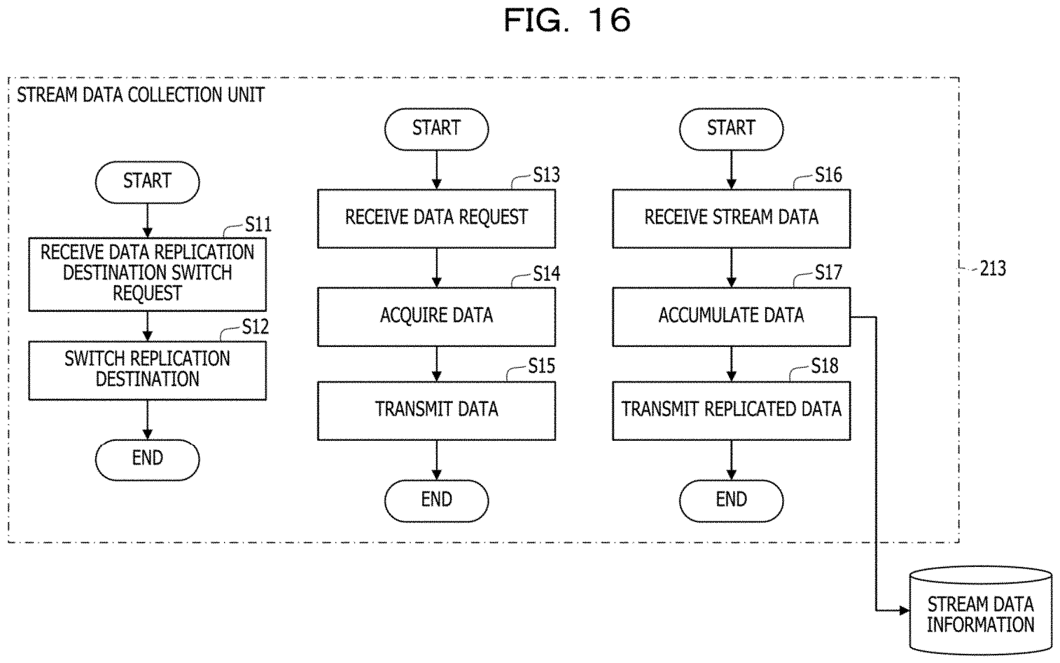

Stream data collection processing in the processing server 2 illustrated in FIG. 7 will be described in accordance with a flowchart (steps S11 to S18) illustrated in FIG. 16. Note that the stream data collection processing includes data replication destination switch processing (steps S11 and S12), data acquisition processing (steps S13 to S15), and stream data accumulation processing (steps S16 to S18).

In the data replication destination switch processing, the stream data collection unit 213 receives a data replication destination switch request from the management server 1 (step S11).

The stream data collection unit 213 switches the data replication destination from its own processing server 2 to another processing server 2 (step S12). Then, the data replication destination switch processing ends.

In the data acquisition processing, the stream data collection unit 213 receives a data request from the management server 1 or another processing server 2 (step S13).

The stream data collection unit 213 acquires data related to the data request from a database (step S14).

The stream data collection unit 213 transmits the acquired data to the management server 1 or another processing server 2 of a transmission source of the data request (step S15). Then, the data acquisition processing ends.

In the stream data accumulation processing, the stream data collection unit 213 receives stream data from the camera 4 (step S16).

The stream data collection unit 213 accumulates the received stream data in a database as stream data information (step S17).

The stream data collection unit 213 transmits replicated data of the stream data to the processing server 2 of the replicated data storage destination (step S18). Then, the stream data accumulation processing ends.

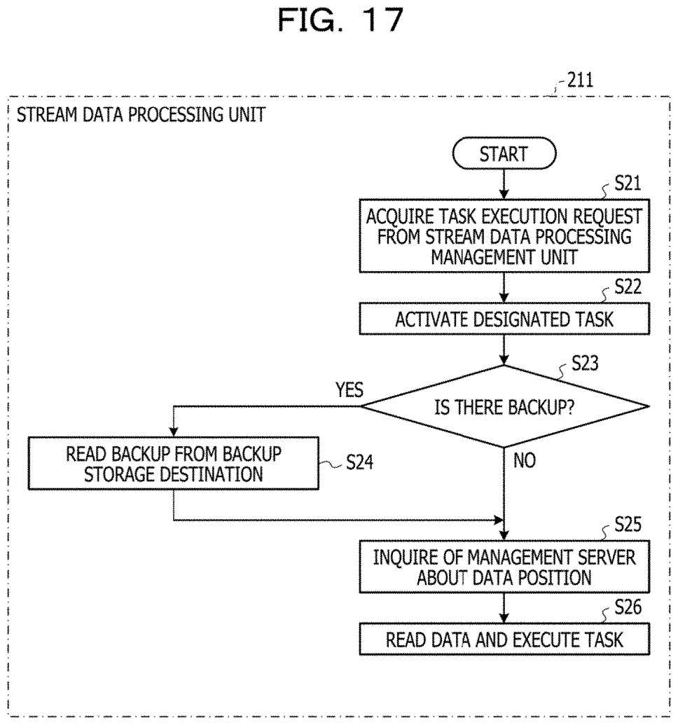

Next, stream data processing in the processing server 2 illustrated in FIG. 7 will be described in accordance with a flowchart (steps S21 to S26) illustrated in FIG. 17.

The stream data processing unit 211 acquires a task execution request from the stream data processing management unit 111 of the management server 1 (step S21).

The stream data processing unit 211 activates a task designated by the task execution request (step S22).

The stream data processing unit 211 determines whether or not there is a backup corresponding to the activated task (step S23).

When there is a backup (see a YES route in step S23), the stream data processing unit 211 reads a backup from the processing server 2 of the backup storage destination (step S24), and the process proceeds to step S25.

Whereas, when there is no backup (see a NO route in step S23), the stream data processing unit 211 inquires of the management server 1 about a position of data corresponding to the activated task (step S25).

The stream data processing unit 211 reads the data and executes the task (step S26). Then, the stream data processing ends.

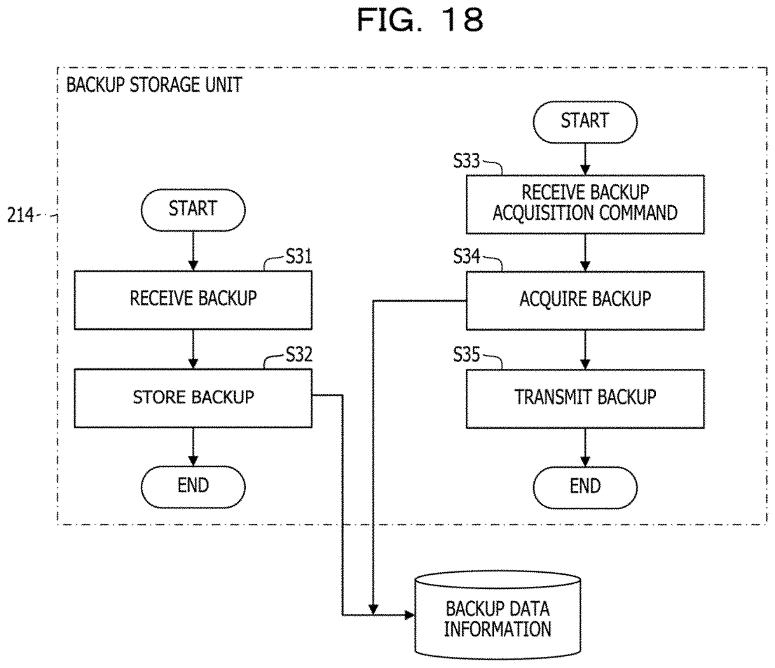

Next, backup storage processing in the processing server 2 illustrated in FIG. 7 will be described in accordance with a flowchart (steps S31 to S35) illustrated in FIG. 18. Note that the backup storage processing includes backup accumulation processing (steps S31 and S32) and backup acquisition processing (steps S33 to S35).

In the backup accumulation processing, the backup storage unit 214 receives backup data from another processing server 2 (step S31).

The backup storage unit 214 stores the backup data in a database as backup data information (step S32). Then, the backup accumulation processing ends.

In the backup acquisition processing, the backup storage unit 214 receives a backup acquisition command from another processing server 2 (step S33).

The backup storage unit 214 acquires backup data from a database (step S34).

The backup storage unit 214 transmits the acquired backup data to another processing server 2 of a transmission source of the backup acquisition command (step S35). Then, the backup acquisition processing ends.

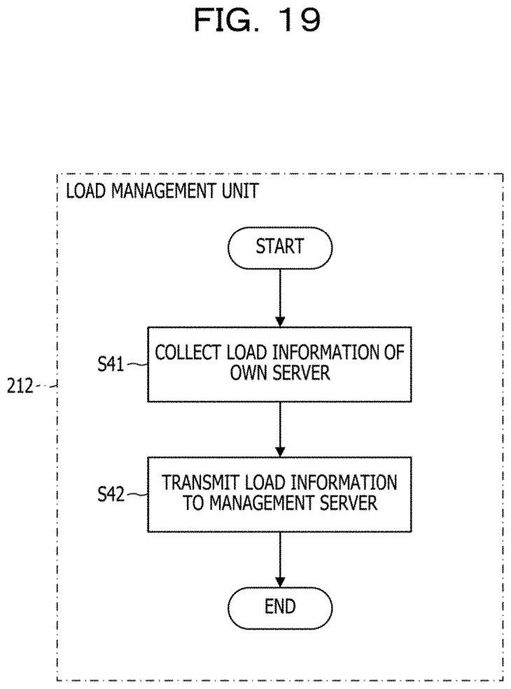

Next, load information collection processing in the processing server 2 illustrated in FIG. 7 will be described in accordance with a flowchart (steps S41 and S42) illustrated in FIG. 19.

The load management unit 212 collects load information o its own processing server 2 (step S41).

The load management unit 212 transmits the collected load information to the management server 1 (step S42). Then, the load information collection processing ends.

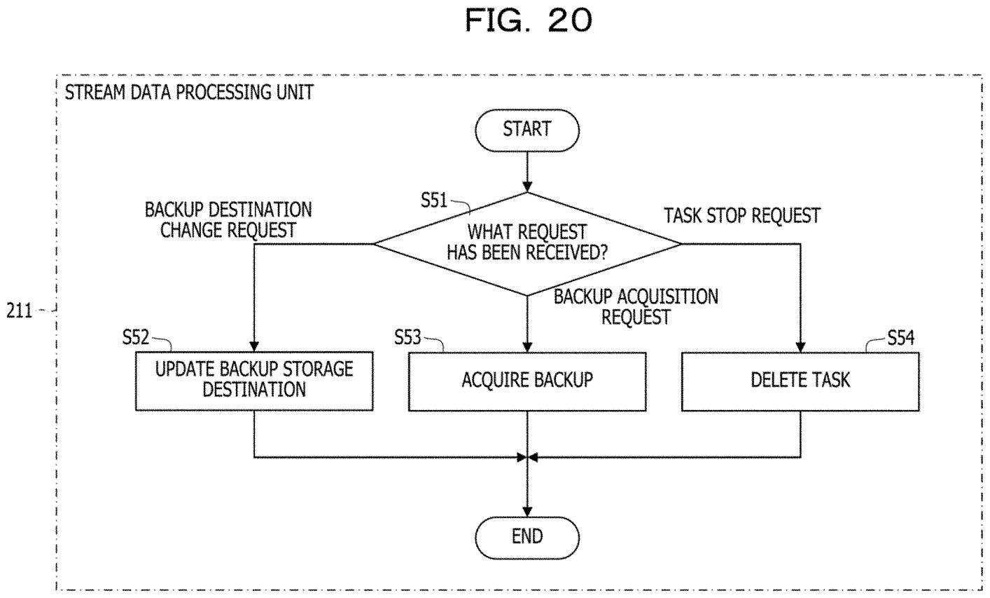

Next, stream data interruption processing in the processing server 2 illustrated in FIG. 7 will be described in accordance with a flowchart (steps S51 to S54) illustrated in FIG. 20.

The stream data processing unit 211 determines what request has been received from the management server 1 (step S51).

When a backup destination change request is received (see a “backup destination change request” route in step S51), the stream data processing unit 211 changes the processing server 2 of the backup storage destination (step S52). Then, the stream data interruption processing ends.

When a backup acquisition request is received (see a “backup acquisition request” route in step S51), the stream data processing unit 211 receives backup data from the database (step S53). Then, the stream data interruption processing ends.

When a task stop request is received (see a “task stop request” route in step S51), the stream data processing unit 211 deletes the task (step S54). Then, the stream data interruption processing ends.

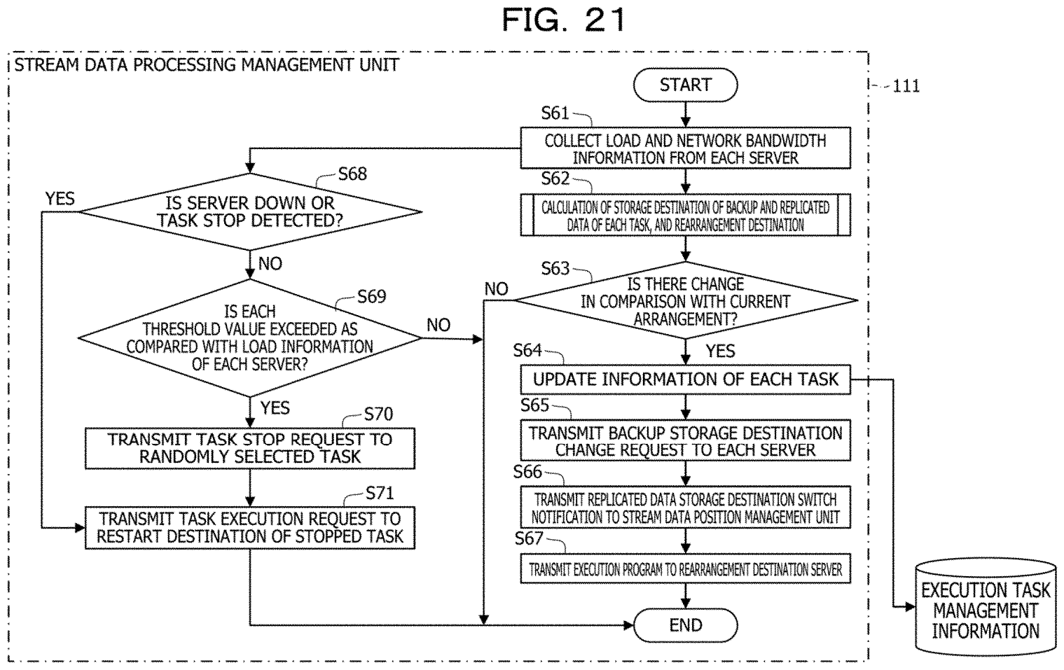

Next, stream data management processing in the management server 1 illustrated in FIG. 7 will be described in accordance with a flowchart (steps S61 to S71) illustrated in FIG. 21.

The stream data processing management unit 111 collects load information and network bandwidth information from each processing server 2 (step S61).

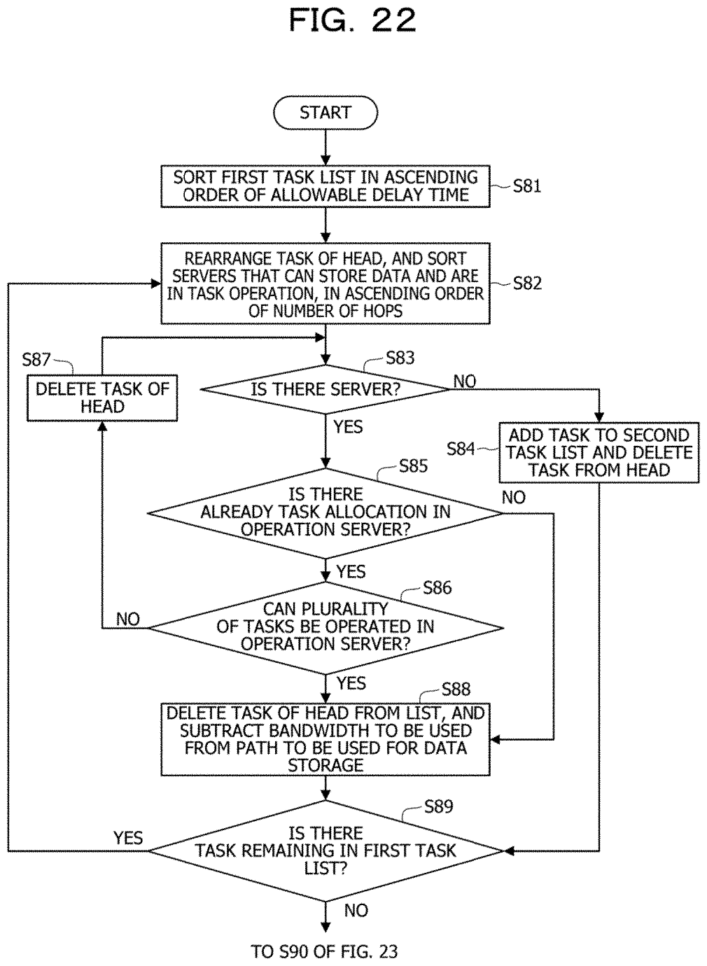

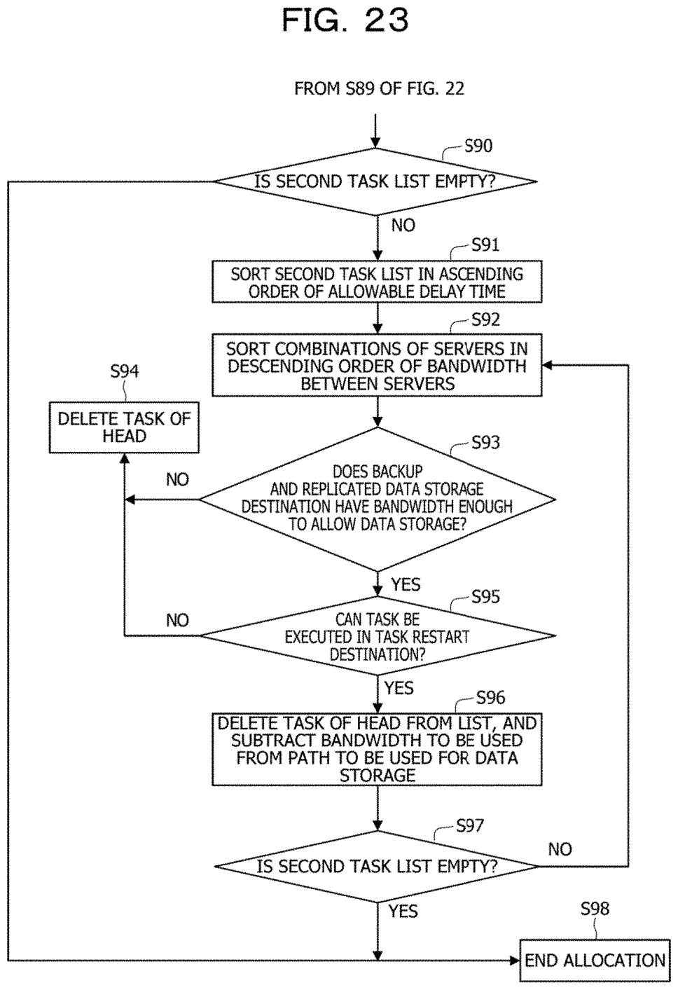

The stream data processing management unit 111 calculates the processing server 2 of a rearrangement destination and the processing server 2 of a storage destination of a backup and replicated data of each task (step S62). Note that details of the processing in step S62 will be described later with reference to FIGS. 22 and 23.

The stream data processing management unit 111 determines whether or not there is a change in comparison with a current arrangement, for the processing server 2 of the storage destination of the backup and the replicated data and the processing server 2 of the rearrangement destination (step S63).

When there is no change in comparison with the current arrangement (see a NO route in step S63), the stream data management processing ends.

Whereas, when there is a change in comparison with the current arrangement (see a YES route in step S63), the stream data processing management unit 111 updates and saves information on each task as execution task management information in a database (step S64).

The stream data processing management unit 111 transmits a backup storage destination change request to each processing server 2 (step 565).

The stream data processing management unit 111 transmits a replicated data storage destination switch notification to the stream data position management unit 112 (step S66).

The stream data position management unit 112 transmits an execution program to the processing server 2 of the rearrangement destination (step S67). Then, the stream data management processing ends.

Furthermore, in parallel with the processing in steps S61 to SS67, the stream data processing management unit 111 determines whether down of the processing server 2 or stop of the task is detected (step S68).

When down of the processing server 2 or stop of the task is detected (see a YES route in step S68), the process proceeds to step S71.

Whereas, when down of the processing server 2 and stop of the task are not detected (see a NO route of step S68), the stream data processing management unit 111 compares load information of each processing server 2 with each threshold value. Then, the stream data processing management unit 111 determines whether a load on each processing server 2 exceeds the threshold value (step S69).

When the load on each processing server 2 does not exceed the threshold value (see a NO route in step S69), the stream data management processing ends.

Whereas, when the load on each processing server 2 exceeds the threshold value (see a YES route in step S69), the process proceeds to step S70. Then, for a task of the processing server 2 randomly selected among the processing servers 2 whose load exceeds the threshold value, the stream data processing management unit 111 transmits a task stop request to the relevant processing server 2 (step S70).

The stream data processing management unit 111 transmits a task execution request to the processing server 2 of a restart destination of the stopped task (step S71). Then, the stream data management processing ends.

Next, details of allocation determination processing in step S62 of FIG. 21 will be described in accordance with a flowchart (steps S81 to S98) illustrated in FIGS. 22 and 23.

The stream data processing management unit 111 sorts a first task list in ascending order of allowable delay time (step S81). Note that the first task list is a set of tasks currently in operation.

The stream data processing management unit 111 rearranges a task of the head. Then, the stream data processing management unit 111 sorts the processing servers 2 that can store data and are in task operation, in ascending order of the number of hops (step S82).

The stream data processing management unit 111 determines whether there is the processing server 2 to be sorted (step S83).

When there is no processing server 2 to be sorted (see a NO route in step S83), the corresponding task is added to a second task list and deleted from the head of the first task list (step S84). Then, the process proceeds to step S89. Note that the second task list is a set of tasks whose allocation has not been determined in the first allocation flow.

Whereas, when there is the processing server 2 to be sorted (see a YES route in step S83), the stream data processing management unit 111 determines whether or not there is already a task allocation in the processing server 2 in operation (step S85).

When there is no task allocation yet (see a NO route in step S85), the process proceeds to step S88.

Whereas, when there is already a task allocation (see a YES route in step S85), the stream data processing management unit 111 determines whether or not a plurality of tasks can be operated in the processing server 2 in operation (step S86).

When it is not possible to operate a plurality of tasks (see a NO route in step S86), a task of the head in the first task list is deleted (step S87), and the process returns to step S83.

Whereas, when a plurality of tasks can be operated (see a YES route in step S86), a task of the head is deleted from the first task list, and a bandwidth to be used is subtracted from a path to be used for data storage (step S88).

The stream data processing management unit 111 determines whether any task remains in the first task list (step S89).

When there is a task remaining in the first task list (see a YES route in step S89), the process returns to step S82.

Whereas, when there is no task remaining in the first task list (see a NO route in step S89), the process proceeds to step S90 in FIG. 23. Then, the stream data processing management unit 111 determines whether the second task list is empty (step S90).

When the second task list is empty (see a YES route in step S90), the process proceeds to step S98.

Whereas, when the second task list is not empty (see a NO route in step S90), the stream data processing management unit 111 sorts the second task list in ascending order of allowable delay time (step S91).

The stream data processing management unit 111 sorts combinations of the processing servers 2 in descending order of a bandwidth between the processing servers 2 (step S92).

The stream data processing management unit 111 determines whether the processing server 2 of the storage destination of the backup and the replicated data has a bandwidth enough to allow data storage (step S93).

When there is not a bandwidth enough to allow data storage (see a NO route in step S93), the stream data processing management unit 111 deletes a task of the head from the second task list (step S94).

Whereas, when there is a bandwidth enough to allow data storage (see a YES route in step S93), the stream data processing management unit 111 determines whether the task can be executed by the processing server 2 of a task restart destination (step S95).

When it is not possible to execute the task (see a NO route in step S95), the process proceeds to step S94.

Whereas, when the task can be executed (see a YES route in step S95), the stream data processing management unit 111 deletes the task of the head from the second task list, and subtracts a bandwidth to be used from a path to be used for data storage (step S96).

The stream data processing management unit 111 determines whether the second task list is empty (step S97).

When the second task list is not empty (see a NO route in step S97), the process returns to step S92.

When the second task list is empty (see a YES route in step S97), the allocation determination processing ends (step S98).

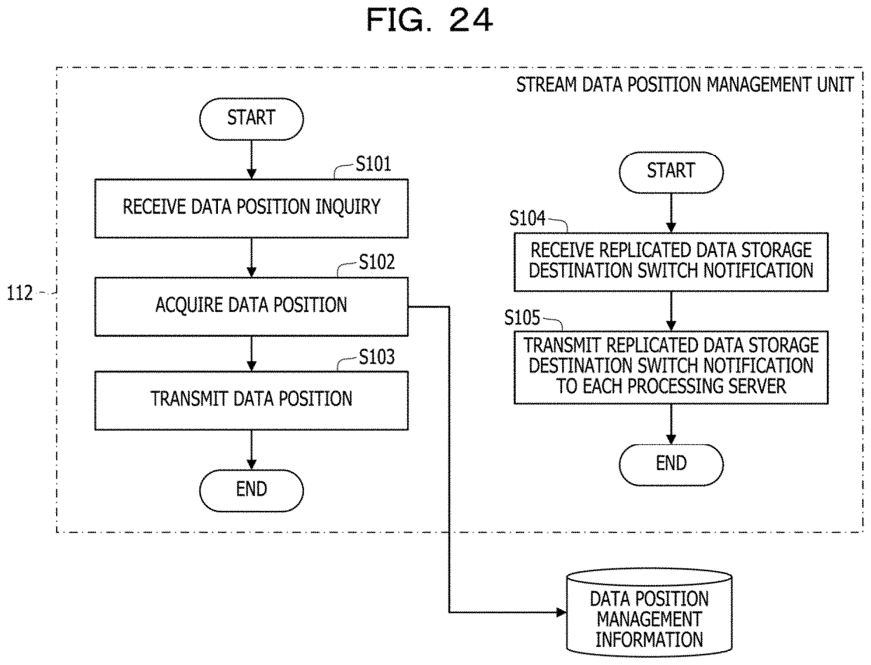

Next, stream data position management processing in the management server 1 illustrated in FIG. 7 will be described in accordance with a flowchart (steps S101 to S105) illustrated in FIG. 24. Note that the stream data position management processing includes data position acquisition processing (steps S101 to S103) and switch notification transmission processing for a replicated data storage destination (steps S104 and S105).

In the data position acquisition processing, the stream data position management unit 112 receives a data position inquiry from the processing server 2 (step S101).

The stream data position management unit 112 acquires a data position from the data position management information (step S102).

The stream data position management unit 112 transmits the data position to the inquiry source processing server 2 (step S103). Then, the data position acquisition processing ends.

In the switch notification transmission processing for the replicated data storage destination, the stream data position management unit 112 receives a switch notification for the replicated data storage destination from the processing server 2 (step S104).

The stream data position management unit 112 transmits the switch notification for the replicated data storage destination to each processing server 2 (step S105). Then, the switch notification transmission processing of the replicated data storage destination ends.

### [B-3] Effect

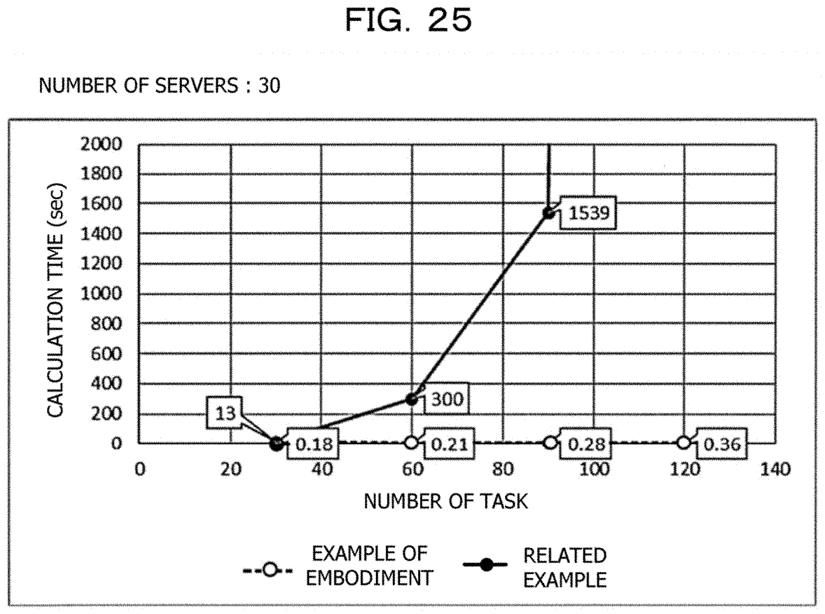

FIG. 25 is a graph illustrating a relationship between the number of tasks and calculation time when obtaining a solution of a rearrangement destination satisfying a delay requirement in a related example and an example of the embodiment.

In a case where the number of processing servers 7 illustrated in FIG. 5 and the like is 30, in a general-purpose solver in the related example, the calculation may be made in about 13 seconds when the number of tasks is 30. However, when the number of tasks is 120, a calculation scale becomes too large to calculate even in one day.

Whereas, by using an algorithm that sorts tasks and servers properly as described above, as illustrated in FIG. 25, when the number of processing servers 2 is 30, the calculation time does not change much even if the number of tasks increases. Furthermore, even if the number of tasks increases to 120, the calculation time is 0.36 sec, and the calculation of the allocation determination processing may be performed in less than 1 second. Therefore, even if the number of tasks and the number of servers increase, the calculation speed of the allocation determination processing may be increased.

According to the management device, the information processing system, and the management program in the example of the embodiment described above, for example, the following operational effects may be obtained.

The load collection unit 1113 of the management server 1 acquires a transfer condition between the first processing server 2 that backs up data related to a task and each of a plurality of second processing servers 2 that are candidates for the task rearrangement destination. Then, the storage location/rearrangement destination calculation unit 1115 of the management server 1 determines, as the processing server 2 of the rearrangement destination, the processing server 2 whose transfer condition satisfies a delay requirement regarding the task, among the plurality of second processing servers 2.

Therefore, the processing server 2 that satisfies the task delay requirement may be selected as the processing server 2 of the task rearrangement destination.

The transfer condition is the number of hops according to the number of SWs 3 installed between the first processing server 2 and the plurality of second processing servers 2.

Therefore, the task may be rearranged by selecting a path with a small number of hops.

The transfer condition is a network bandwidth between the plurality of second processing servers 2 and the SW 3 installed between the first processing server 2 and the plurality of second processing servers 2.

Therefore, the task may be rearranged by selecting a path with a large network bandwidth.

The load collection unit 1113 of the management server 1 acquires loads on the plurality of second processing servers 2 in addition to the transfer condition. The storage location/rearrangement destination calculation unit 1115 of the management server 1 preferentially determines, as the processing server 2 of the rearrangement destination, the processing server 2 having a low load among the plurality of second processing servers 2.

Therefore, it is possible to avoid concentration of the load on the specific processing server 2.

### [C] Other

The disclosed technology is not limited to the above-described embodiment, and various modifications may be implemented without departing from the spirit of the present embodiment. Each configuration and each process of the present embodiment may be selected according to need, or may be appropriately combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management device comprising:
a memory; and
a processor coupled to the memory and configured to:
acquire a transfer condition between a first processing device that backs up data related to a task, and each of a plurality of second processing devices that are candidates for a rearrangement destination of the task; and
determine, as a processing device of the rearrangement destination, a processing device that satisfies a delay requirement related to delay time of processing in which the transfer condition is set for the task, among the plurality of second processing devices.

2. The management device according to claim 1, wherein the transfer condition is a number of hops according to a number of switches installed between the first processing device and the plurality of second processing devices.

3. The management device according to claim 1, wherein the transfer condition is a network bandwidth between the plurality of second processing devices and a switch installed between the first processing device and the plurality of second processing devices.

4. The management device according to claim 1, wherein the processor is configured to:
acquire a load on the plurality of second processing devices in addition to the transfer condition, and
determine, as a processing device of the rearrangement destination, a processing device on which the load is low among the plurality of second processing devices.

5. The management device according to claim 1, wherein the processor is configured to:
perform sorting of a plurality of e tasks in ascending order of he delay time, and
use, as the transfer condition, a number of hops according to a number of switches installed between the first processing device and the plurality of second processing devices, to determine, as a processing device of the rearrangement destination, a processing device in ascending order of the number of hops, for each of the plurality of tasks, in order of the sorting.

6. The management device according to claim 5, wherein the processor is configured to:
use, as the transfer condition, a network bandwidth between the plurality of second processing devices and a switch installed between the first processing device and the plurality of second processing devices, to determine, as a processing device of the rearrangement destination, a processing device in descending order of the network bandwidth, in order of the sorting, for each of the plurality of tasks for which a processing device of the rearrangement destination based on the number of hops has not been determined.

7. An information processing system comprising:
a management device;
a first processing device that backs up data related to a task; and
a plurality of second processing devices that are candidates for a rearrangement destination of the task, wherein
each of the plurality of second processing devices
transmits a transfer condition between the first processing device and each of the plurality of second processing devices to the management device, and
the management device
determines, as a processing device of the rearrangement destination, a processing device that satisfies a delay requirement related to delay time of processing in which the transfer condition is set for the task, among the plurality of second processing devices.

8. The information processing system according to claim 7, wherein the transfer condition is a number of hops according to a number of switches installed between the first processing device and the plurality of second processing devices.

9. The information processing system according to claim 7, wherein the transfer condition is a network bandwidth between the plurality of second processing devices and a switch installed between the first processing device and the plurality of second processing devices.

10. The information processing system according to claim 7, wherein
each of the plurality of second processing devices
transmits a load on the plurality of second processing devices to the management device, in addition to the transfer condition, and
the management device
preferentially determines, as a processing device of the rearrangement destination, a processing device on which the load is low among the plurality of second processing devices.

11. The information processing system according to claim 7, wherein
the management device
performs sorting of a plurality of the tasks in ascending order of the delay time, and
uses, as the transfer condition, a number of hops according to a number of switches installed between the first processing device and the plurality of second processing devices, to determine, as a processing device of the rearrangement destination, a processing device in ascending order of the number of hops, for each of the plurality of tasks, in order of the sorting.

12. The information processing system according to claim 11, wherein
the management device
uses, as the transfer condition, a network bandwidth between the plurality of second processing devices and a switch installed between the first processing device and the plurality of second processing devices, to determine, as a processing device of the rearrangement destination, a processing device in descending order of the network bandwidth, in order of the sorting, for each of the plurality of tasks for which a processing device of the rearrangement destination based on the number of hops has not been determined.

13. A non-transitory computer-readable recording medium having stored therein a management program for causing a computer to execute a process comprising:
acquiring a transfer condition between a first processing device that backs up data related to a task, and each of a plurality of second processing devices that are candidates for a rearrangement destination of the task; and
determining, as a processing device of the rearrangement destination, a processing device that satisfies a delay requirement related to delay time of processing in which the transfer condition is set for the task, among the plurality of second processing devices.

14. The non-transitory computer-readable recording medium having stored therein a management program for causing a computer to execute a process according to claim 13, wherein the transfer condition is a number of hops according to a number of switches installed between the first processing device and the plurality of second processing devices.

15. The non-transitory computer-readable recording medium having stored therein a management program for causing a computer to execute a process according to claim 13, wherein the transfer condition is a network bandwidth between the plurality of second processing devices and a switch installed between the first processing device and the plurality of second processing devices.

16. The non-transitory computer-readable recording medium having stored therein a management program for causing a computer to execute a process according to claim 13, wherein the computer is caused to execute a process of:
acquiring a load on the plurality of second processing devices in addition to the transfer condition; and
preferentially determining, as a processing device of the rearrangement destination, a processing device on which the load is low among the plurality of second processing devices.

17. The non-transitory computer-readable recording medium having stored therein a management program for causing a computer to execute a process according to claim 13, comprising:
sorting a plurality of the tasks in ascending order of the delay time; and
using, as the transfer condition, a number of hops according to a number of switches installed between the first processing device and the plurality of second processing devices, to determine, as a processing device of the rearrangement destination, a processing device in ascending order of the number of hops, for each of the plurality of tasks, in order of the sorting.

18. The non-transitory computer-readable recording medium having stored therein a management program for causing a computer to execute a process according to claim 17, comprising:
using, as the transfer condition, a network bandwidth between the plurality of second processing devices and a switch installed between the first processing device and the plurality of second processing devices, to determine, as a processing device of the rearrangement destination, a processing device in descending order of the network bandwidth, in order of the sorting, for each of the plurality of tasks for which a processing device of the rearrangement destination based on the number of hops has not been determined.
